(19) United States
(12) Patent Application Publication
(10) Pub. No.: US 2016/0200292 A1
(43) Pub. Date: Jul. 14, 2016

(54) Wheel Cover System

(71) Applicant: Manuel Valles, Santa Barbara, CA (US)

(72) Inventor: Manuel Valles, Santa Barbara, CA (US)

(21) Appl. No.: 14/592,971

(22) Filed: Jan. 9, 2015

(51) Int. Cl. B60S 3/04; B60B 7/06

(52) U.S. Cl. CPC B60S 3/042; B60B 7/06

(57) ABSTRACT

A wheel cover system includes a wheel that may be coupled to a vehicle The wheel has an exposed lateral surface and an outer edge. A tire has a front side and the front side has an opening extending therethrough. The tire is coupled to the wheel such that a bounding edge of the opening abuts the outer edge of the wheel leaving the exposed lateral surface exposed. A panel is provided that is comprised of a rigid and fluid impermeable material. A plurality of hooks is each coupled to the panel. The hooks engage the wheel to retain the panel on the wheel. The panel prevents a cleaner from contacting the exposed lateral surface when the cleaner is applied to the front side of the tire.

### BACKGROUND OF THE DISCLOSURE

### Field of the Disclosure

The disclosure relates to wheel cover devices and more particularly pertains to a new wheel cover device for preventing a cleaner that is applied to a tire from contacting a wheel that has the tire coupled thereto.

### SUMMARY OF THE DISCLOSURE

An embodiment of the disclosure meets the needs presented above by generally comprising a wheel that may be coupled to a vehicle The wheel has an exposed lateral surface and an outer edge. A tire has a front side and the front side has an opening extending therethrough. The tire is coupled to the wheel such that a bounding edge of the opening abuts the outer edge of the wheel leaving the exposed lateral surface exposed. A panel is provided that is comprised of a rigid and fluid impermeable material. A plurality of hooks is each coupled to the panel. The hooks engage the wheel to retain the panel on the wheel. The panel prevents a cleaner from contacting the exposed lateral surface when the cleaner is applied to the front side of the tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a wheel cover system according to an embodiment of the disclosure.

FIG. 2 is a back view of an embodiment of the disclosure.

FIG. 3 is a right side view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

FIG. 6 is a front side in-use view of an embodiment of the disclosure.

### DESCRIPTION OF THE PREFERRED EMBODIMENT

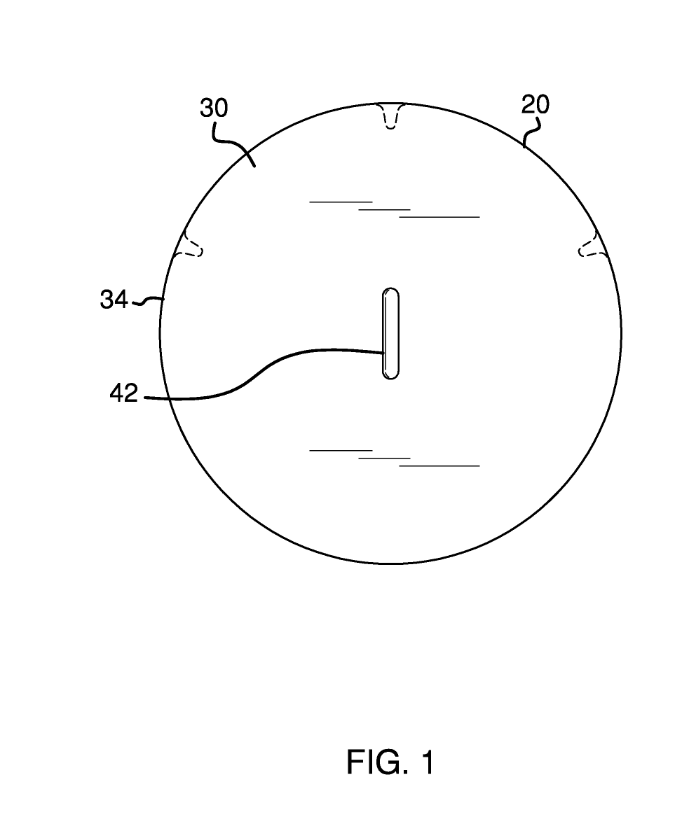

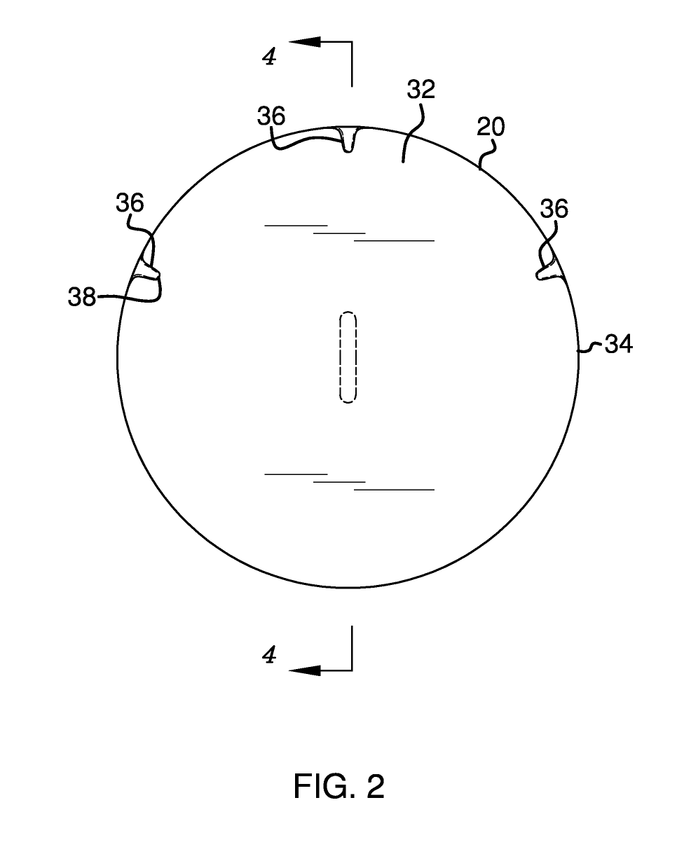

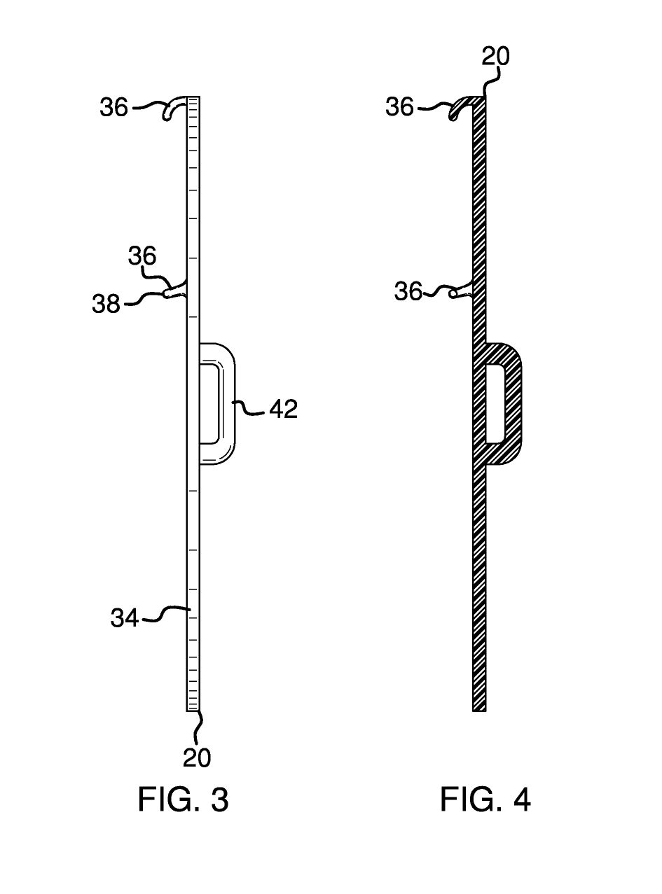

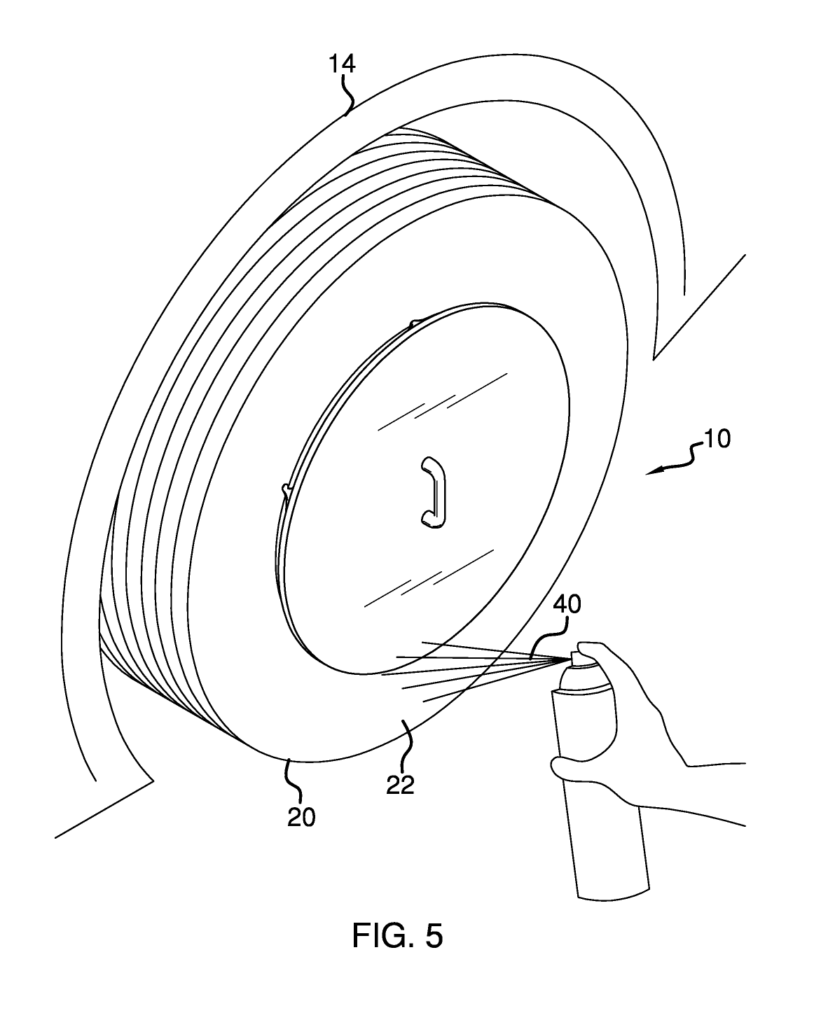

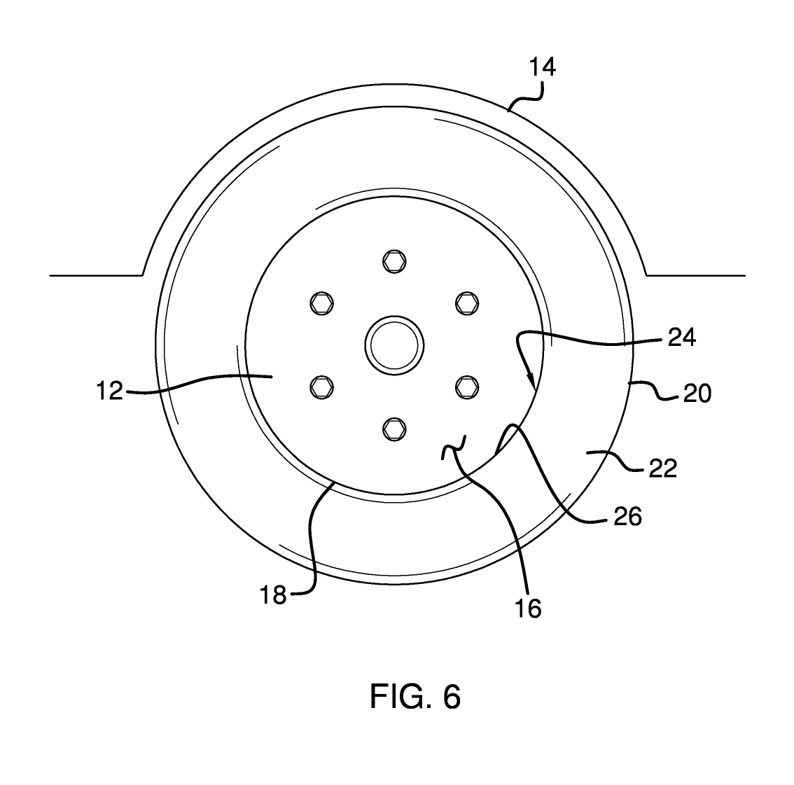

With reference now to the drawings, and in particular to FIGS. 1 through 6 thereof, a new wheel cover device embodying the principles and concepts of an embodiment of the disclosure and generally designated by the reference numeral 10 will be described.

As best illustrated in FIGS. 1 through 6, the wheel cover system 10 generally comprises a wheel 12 that may be coupled to a vehicle 14. The vehicle 14 may be a passenger vehicle or the like. The wheel 12 has an exposed lateral surface 16 and an outer edge 18. The wheel 12 may be an automotive wheel of any conventional design.

A tire 20 is provided that has a front side 22 and the front side 22 has an opening 24 extending therethrough. The tire 20 is coupled to the wheel 12 such that a bounding edge 26 of the opening 24 abuts the outer edge 18 of the wheel 12 leaving the exposed lateral surface 16 exposed. The tire 20 may be an automotive tire of any conventional design.

A panel 28 is provided that has a forward side 30, a rearward side 32 and a perimeter edge 34 extending therebetween. The panel 28 is comprised of a rigid and fluid impermeable material. A plurality of hooks 36 is each coupled to the rearward side 32 and each of the hooks 36 extends rearwardly from the rearward side 32. Each of the hooks 36 has a free end 38 and each of the hooks 36 is arcuate between the panel 28 and the free end 38 such that the free end 38 is directed toward a center of the rearward side 32. The panel 28 may be provided with various diameters to match a diameter of various sizes of wheels 12.

Each of the hooks 36 is positioned adjacent to the perimeter edge 34 and the hooks 36 are spaced from each other. The free end 38 of each of the hooks 36 releasably engages the outer edge 18 of the wheel 12 such that the panel 28 covers the exposed lateral surface 16. The panel 28 may prevent a cleaner 40 from contacting the exposed lateral surface 16 when the cleaner 40 is applied to the front side 22 of the tire 20. The cleaner 40 may be a tire dressing compound or other cleaner used in the treatment, preservation and cleaning of rubber tires. A handle 42 is coupled to the forward side 30 of the panel 28.

In use, the panel 28 is coupled to the wheel 12 so the panel 28 completely covers the exposed lateral surface 16 of the wheel 12. The cleaner 40 is applied to the front side 22 of the tire 20. After the cleaner 40 has been utilized, the panel 28 is removed from the wheel 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheel cover system configured to prevent a tire cleaning from being applied on a wheel, said assembly comprising:
a wheel configured to be coupled to a vehicle, said wheel having an exposed lateral surface and an outer edge;
a tire having a front side, said front side having an opening extending therethrough, said tire being coupled to said wheel such that a bounding edge of said opening abuts said outer edge of said wheel leaving said exposed lateral surface exposed;
a panel comprised of a rigid and fluid impermeable material; and
a plurality of hooks each coupled to said panel, said hooks engaging said wheel to retain said panel on said wheel, said panel being configured to prevent a cleaner from contacting said exposed lateral surface when the cleaner is applied to said front side of said tire.

2. The system according to claim 1, wherein said panel has a forward side, a rearward side and a perimeter edge extending therebetween, each of said hooks being coupled to said rearward side, each of said hooks extending rearwardly from said rearward side, each of said hooks having a free end, each of said hooks being arcuate between said panel and said free ends such that said free end is directed toward a center of said rearward side.

3. The system according to claim 2, wherein each of said hooks said hooks is positioned adjacent to said perimeter edge, said hooks being spaced from each other, said free end of each of said hooks releasable engaging said outer edge of said wheel such that said panel covers said exposed lateral surface.

4. The system according to claim 2, further comprising a handle coupled to said forward side.

5. A wheel cover system configured to prevent a tire cleaning from being applied on a wheel, said assembly comprising:
a wheel configured to be coupled to a vehicle, said wheel having an exposed lateral surface and an outer edge;
a tire having a front side, said front side having an opening extending therethrough, said tire being coupled to said wheel such that a bounding edge of said opening abuts said outer edge of said wheel leaving said exposed lateral surface exposed;
a panel having a forward side, a rearward side and a perimeter edge extending therebetween, said panel being comprised of a rigid and fluid impermeable material;
a plurality of hooks each coupled to said rearward side, each of said hooks extending rearwardly from said rearward side, each of said hooks having a free end, each of said hooks being arcuate between said panel and said free ends such that said free end is directed toward a center of said rearward side, each of said hooks said hooks being positioned adjacent to said perimeter edge, said hooks being spaced from each other, said free end of each of said hooks releasable engaging said outer edge of said wheel such that said panel covers said exposed lateral surface, said panel being configured to prevent a cleaner from contacting said exposed lateral surface when the cleaner is applied to said front side of said tire; and
a handle coupled to said forward side.
